(19) United States
(12) Patent Application Publication
(10) Pub. No.: US 2020/0046475 A1
(43) Pub. Date: Feb. 13, 2020

(54) Kite Gum Brush

(71) Applicants: Prajeshkumar Y. Desai, Dublin, CA (US); Estela Victoria, Dublin, CA (US)

(72) Inventors: Prajeshkumar Y. Desai, Dublin, CA (US); Estela Victoria, Dublin, CA (US)

(21) Appl. No.: 15/998,379

(22) Filed: Aug. 13, 2018

(51) Int. Cl. A61C 15/04; A61C 15/02

(52) U.S. Cl. CPC A61C 15/046; A46B 2200/108; A61C 15/02

(57) ABSTRACT

A kite shaped brush head, structured for cleaning and stimulating tissues between the teeth, includes plurality of wire bristles with varying length size fanning radially outward from the handle. From the tip of upper handle region facing the tongue side, the first plurality of wire bristles may have incrementally increasing length from the tip to a pre-determined length to form an upward slope; with second plurality of wire bristles having a decreasing length from the end of the first plurality of wire bristles to form a downward slope up to a pre-determined length. The lower handle region, used on the gum side, contains plurality of bristle fans with varying and equivalent length. From the tip of the lower handle region, a third plurality of wire bristles having same length bristles from the tip to a pre-determined length to form a parabolic region to traverse the gum line. When viewed from the top or bottom, the brush may have a kite shape.

### BACKGROUND

Removing foreign particles from between the teeth reduces the possibility of cavities and the buildup of plaque. This may lead to gum diseases and possible loss of teeth. A typical approach to this problem is to have frequent sessions with a dental hygiene technician at which time already formed plaque is removed, cavities are noted and filled and further needed treatment can be provided. An individual may home clean to remove foreign particles and deter plaque buildup. This requires an individual to home clean one or more times a day.

Home cleaning may be accomplished using a toothbrush. A conventional toothbrush is ill adapted for cleaning between the teeth. The toothbrush cleans the buccal or cheek side of the teeth much more effectively than the lingual, or tongue side of top and bottom teeth. This is because the embrasure from the cheek side is much smaller than the exit of the brush in the tongue side. Due to the anatomy of teeth, one side of the teeth cleans better than the other. Another issue is the length of these brushes. They may be too short, and have the orientation of bristles not touching all of the surfaces possible in this interproximal space. The Interproximal space is approximately triangular with dome shape gum line. There may be some papilla left where the base of this triangular space is slightly lifted.

A conventional interdental brush may be used to clean between teeth. Interdental (interproximal) brushes are usually triangular shaped small brushes fitting onto a plastic handle, like little bottlebrushes. Some interdental brushes can also be cylindrical and conical shaped, which can be utilized to clean between adjacent teeth. Other dental tools such as floss, interdental picks or sticks, interdental rubber tip stimulators, pulsating water or medicament spraying devices or single tuft toothbrushes, can also be utilized for cleaning between the teeth. Although these latter devices accomplish a measure of inter-teeth cleaning their efficiency of operation can be desirably improved especially where distinct pockets exist between adjacent teeth.

### SUMMARY

In accordance, the first example embodiment, a kite shaped interproximal brush includes distinguished kite shape for superior gum cleaning. The key brush design features can be viewed from three vantage points: top or base (kite shape feature), side (semi-kite shape feature), and the front tip and base (upside down parabolic shape feature). The bottom or the base has dual key design features. The base has both kite shape and upside down parabolic. From the side cross-section view, the brush can be seen to have semi-kite shape with, for example,

1). an upper bristle fan configuration with half kite shape and
2). lower bristle fan configuration with flat horizontal shape.

The kite brush may be inserted in the space between two adjacent teeth. The kite shape is designed to be form fitted to the shape of the teeth and gum line. The base of the brush features kite design and upside down parabolic shape. The parabolic shape of the kite brush positions perfectly above the parabolic gum line. Thus the parabolic shape cleans the gum section more precisely when the brush is moved parallel to the gum line. From top and base view, the kite shape may fit between teeth more precisely. The top and sides of the kite brush remove particles from the top and mid-teeth section and the bottom side of the brush removes particles from the gum and bottom-teeth section.

In a first embodiment, the individual brush bristles/elements are secured to a wire core. The core may be coated with a protective plastic material. In a second example embodiment, the brush filaments and elongated central core are molded from a synthetic plastic material.

By the way of example, the kite brush cleans a space in between the teeth called the interproximal space. The interproximal space exists when the gum in between the teeth, specifically called the papilla, recedes. This may be due to periodontal surgery, healing processes from years of gum disease or from use of toothpicks or other abrasive tools. It is also a natural process of aging, although lessened in some individuals. Food consistently sits in it at meal times, producing larger amounts of plaque. Plaque is the substance which forms from the normal bacteria in our mouth ingesting sugars or carbohydrates in between the teeth. It forms in larger amounts in older populations who have more difficulty keeping these spaces clean and free of food.

Conventional brushes remove this sticky substance called plaque, from as many surfaces as possible, at or below the gum line and in between this interproximal space to control gum disease. Also, gum pockets exist in between teeth and are usually deeper so these need to be kept clean. A healthy gum pocket is 1-3 mm in depth. Gum disease increases this depth making these areas deeper. Deeper gum lines causes more bleeding in these pockets. This is active gum disease.

Because of the kite shape, the brush beneficially enables the lingual or tongue side of the teeth to be cleaned more efficiently since it reaches the widest point of the lingual embrasures with the widest part of the brush. Most patients do not introduce any interproximal brush from the lingual side, because of manual dexterity problems, and because it is easier to introduce into the space from the cheek side. The parabolic design of the bottom half of brush precisely fits the gum side. Since a typical natural shape of the gum is an upside down parabola, the parabolic design is beneficially complementary to the bottom of the kite gum brush design.

### BRIEF DESCRIPTION OF DRAWINGS

FIG. 1 illustrates the top cross-section view of the full brush with brush head on distal side of the handle and floss pick on the proximal side of the handle in one example embodiment;

FIG. 2 illustrates the top cross-section view of the full brush with brush head on distal side of the handle and floss pick on the proximal side of the handle in one example embodiment;

FIG. 3 illustrates top cross-section view of the kite brush head with brush wire in one example embodiment;

FIG. 4 illustrates side cross-section view of kite brush head with plurality bristle fans in one example embodiment;

FIG. 5 illustrates straight on view of kite brush from the tip of the brush head in one example embodiment;

FIG. 6 illustrates proximal end of handle with floss pick in one example embodiment;

FIG. 7 illustrates the kite brush between the teeth in one example embodiment.

### DETAILED DESCRIPTION

A kite shaped brush alleviates dental problems caused by plaque, cavities, and/or gum disease. The present configuration kite shape fits precisely within the narrow space between the teeth. The kite shape removes foreign matter quickly and efficiently thus reducing gum disease.

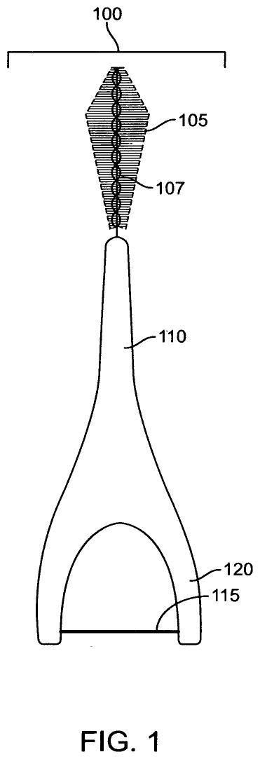

FIG. 1 illustrates the top cross-section view of the full brush with brush head on distal side of the handle and floss pick on the proximal side of the handle in one example embodiment. FIG. 1 illustrates the top view of a kite gum brush 100. The brush 100 includes a kite brush head 105, a wire core 107, a brush handle 110, a floss pick 120, and a floss thread 115. The brush 100 includes the kite brush head 105 on the distal end and the floss pick 120 on the proximal end. The floss pick 120 includes floss thread 115. Between the brush head 105 and the floss pick 120 is handle 110. The handle 110 has a narrow grip on the distal end and a thicker, wider grip on the proximal end. The kite brush head 105 contains plurality of wire bristles at different length fanning radially outward from the wire core 107. The floss pick 120 has a curved Y shape handle. The floss wire 115 may be attached to the floss handle on the two top ends of the Y. The curved Y shape helps to clean between the teeth better without interference from the kite brush head 105.

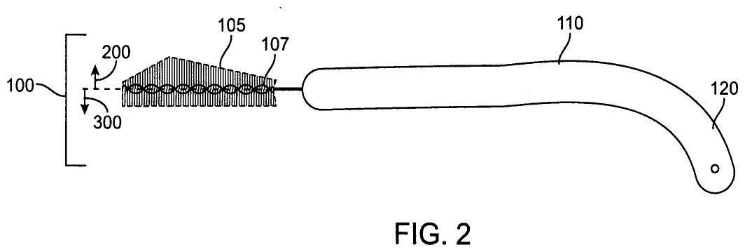

FIG. 2 illustrates the side cross-section view of the full brush with brush head on distal side of the handle and floss pick on the proximal side of the handle in one example embodiment. FIG. 2 illustrates the side view of the kite gum brush 100. The brush 100 includes kite brush head 105 on the distal end and floss pick 120 on the proximal end. Between kite brush head 105 and floss pick 120 is handle 110. The kite brush head 105 contains plurality of wire bristles at different length fanning radially outward from the wire core 107. The kite brush head 105 has wire core 107 that includes a upper handle region 200 and a lower handle region 300. The kite brush head 105 further comprises of varying size bristle fans on the upper handle region 200. The upper handle region 200 starts from the wire core 107 to the upper region of brush head 105. The lower handle region 300 has same length bristles from the wire core 107 to the bottom of the brush head 105.

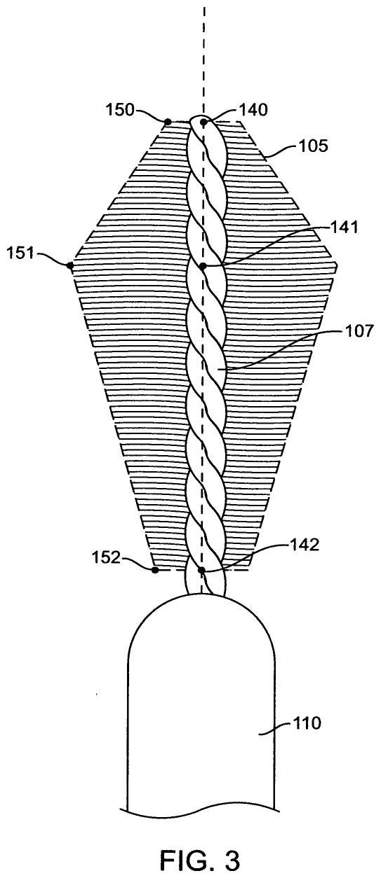

FIG. 3 illustrates top cross-section view of the kite brush head 105 with wire core 107 in one example embodiment. The kite brush head 105 may have plastic bristles entwined in wire core 107. For example the diameter of the wire core 107 may be for example, 0.5 mm. The bristles on both end of wire core are equidistant from the center of the wire core 107. The plurality of bristles can be wrapped around the wire core 107 and projected radially outward to a pre-defined length. The plurality of bristles can be trimmed to form a kite shape. The wire core includes a center tip 140, another center point 141, and end center endpoint 142. The wire core 107 starts at a center tip 140 of the brush head 105 and ends at the brush handle 110. Center tip 140 is located at the center of the top end (distal side) of the wire core 107. From the center tip 140, point L1, the bristles on the brush head 105 have a certain fixed length to an edge 150. From the edge 150, point P1, bristles fan out in gradually increasing size to maximum bristle edge 151, point P2. Location 141, at point L2, on wire core 107 is located directly below center tip 140, point P1. Point L2 is shown as horizontal straight line to point P2. From maximum bristle edge 151, the bristles fan out in gradually decreasing manner up to 152, point P3. Location 142, at point L3, on wire core 107 is located directly below center tip 140 and location 141 and may form a straight line to point P3.

The kite brush head 105 derives its shape from distance shaping between all pertinent points. For example, from the point L1 (140) to P1 (150) may be 1.5 mm. Since the bristles are equidistant from the wire core, end to end from P1 to P1′ may be for example, 3 mm. The hypotenusal distance from P1 (150) to P2 (151) may be slightly over for example, 6 mm; the distance from point L1 (140) to L2 (141) may be for example, 5 to 6 mm; the distance from L2 (141) to P2 (151) may be for example, 3.5 mm. Since the bristles are equidistant from wire core 107, the distance from P2 to P2′ may be for example, 7 mm. The hypotenusal distance from P2 (151) to P3 (152) may be slightly over for example, 12 mm; the distance from L2 (141) to L3 (142) may be for example, 12 mm; the distance from P3 to P3′ may be for example, 3.5 to 4 mm.

From point L1 to point L3 may be, for example, 17-18 mm apart. The null space between wire core 107 at point L3 and the brush handle 110 may be approximately 3 mm. The kite shape is due to starting point P1 to gradually increasing sloped point P2 and gradually decreasing sloped point P3 and P1′ to gradually increasing sloped point P2′ and gradually decreasing sloped point P3′.

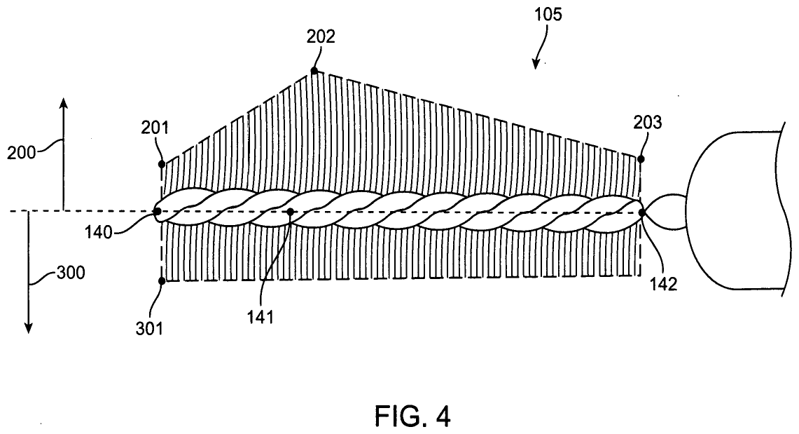

FIG. 4 illustrates side or lateral cross-section view of kite brush head 105 with plurality of bristle fans in one example embodiment. The brush head 105 is located on the distal side of the kite gum brush 100 with wire core 107 connecting the center tip 140 to handle 110. The plurality of bristles may be wrapped around the wire core 107 and projected radially outward to a pre-defined length. The brush head 105 further comprises of varying size bristle fans on the upper handle region 200. The upper handle region 200 starts from the center of wire core 107 to the upper region of the brush head. The upper handle region has varying size bristles. The lower handle region 300 starts from the center of the wire core 107 to the lower region of the brush head. The lower handle region 300 has same length bristles from the wire core 107 to the bottom of the brush head 105. The upper handle region has one-sided kite shape. The lower region has horizontal flat shape with upside-down parabolic outline.

The upper handle region 200, when in between the teeth, faces the tongue side. The upper handle region 200 contains plurality of bristle fans with varying length. From the center tip 140, point L1, on the upper handle region 200, the first plurality of wire bristles 201 are lined up to length T1. From 201, an incrementally increasing length of wire bristle exists up to 202, point T2. From points T1 to T2, an upward slope occurs. A second plurality of wire bristles from 202 having an incrementally decreasing length up to 203, pre-determined fixed point T3. From points T2 to T3, there exists a downward slope.

From the center tip 140, point L1, the bristles on brush head 105 has a certain fixed length up to point T1. The distance from L1 to T1 may be for example, 2.5 mm; the length from L2 to T2 may be for example, 3.5 mm and; the distance from L3 to T3 may be for example, 2.5 mm.

The lower handle region 300, when in between the teeth, touches and cleans the gum line. The lower handle region 300 contains plurality of bristle fans from wire core 107 with maximum same length bristles 301, point Z1. The bristles 301 have equal length from wire core 107 to the gum line. In one embodiment, for example, the bristle length from wire center tip 140, point P1 to Z1 may be for example, 2.5 mm. As mentioned above, length from L1 to L3 may be for example, 17-18 mm.

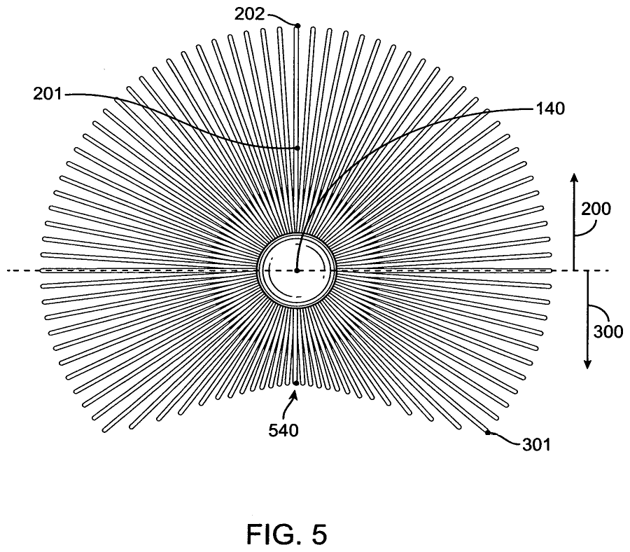

FIG. 5 illustrates straight on view of kite brush from the tip of the brush head in one example embodiment. The upper handle region 200 shows the plurality of bristle fans with the varying lengths. This straight on viewpoint of the upper handle region 200 starts at wire core tip 140 and is depicted up to first plurality of bristles 201. From first plurality of bristles 201, there is gradual increase to the highest slope bristles 202. As mentioned in FIG. 4, the bristles at wire core tip 140, point L1, to first plurality of bristles 201 (upper handle point T1) may be for example, 2.5 mm. At the highest slope bristles 202, point L2, the upper handle distance from wire core tip 141 (shown in FIG. 4), point L2 to point T2 may be for example, 3.5 mm.

The lower handle region 300 formation is an upside down parabola. This shape fits along the parabolic gum line in a manner that complements the shape of the gum line. For example, the shortest distance of the parabola from the wire core tip 140, point L1, is at maximum point of parabola 540 or point D1. The distance from L1 to D1 may be for example, 1.5 mm. The bristle fans will gradually increase from 540 to parabolic maximum lower region bristles 301. The maximum distance from wire core tip 140, point L1 to Z1 may be for example, 2.5 mm from the center of the parabola.

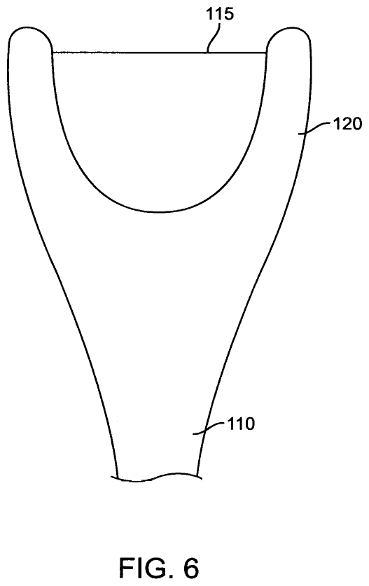

FIG. 6 illustrates proximal end of handle with floss pick in one example embodiment. The proximal side handle 110 has a wider base to house the floss wire 115 in floss pick 120. The floss pick 120 has a curved Y shape to reach areas in between teeth where the regular toothbrush cannot reach. The curved Y shape also keeps the kite brush head 105 away from the mouth it so does not interfere with flossing.

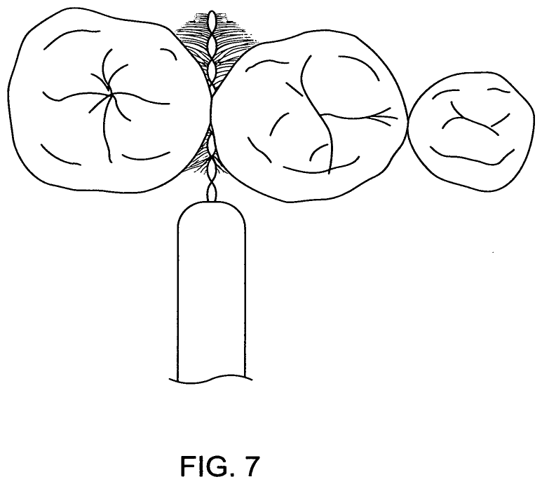

FIG. 7 illustrates the kite brush between the teeth in one example embodiment. The kite gum brush 100 has an ideal shape to fit in between teeth and on top of the gum line. It is best suited to clean these areas.

While several embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of preferred embodiments. Those skilled in the art will envision other modifications within the scope and spirit of the claims appended hereto.

1. A interproximal kite brush for cleaning teeth comprising:
a handle with distal end and proximal end;
a bristle head portion located at the distal end comprised of plurality of bristle fans arranged in a kite pattern on a wire core.

2. The kite brush of claim 1, further comprising of bristle fans coupled radially outward with varying length from the wire core.

3. The kite brush of claim 2, further comprising of bristle fans with an upper handle region and a lower handle region.

4. The kite brush of claim 3, further comprising of the upper region bristle fans with a first plurality of wire bristles having increasing length from a tip of the handle to form an upward slope to a tallest region and a second plurality of wire bristle with a decreasing length from the tallest region forming a downward slope to a length on the handle traversing away from the tip of the handle.

5. The kite brush of claim 3, further comprising of the gum line lower region bristle fans with same length bristles traversing away from the tip of the handle

6. The kite brush of claim 1, further comprising a proximal end curve Y floss pick.
